(19) United States
(12) Patent Application Publication
(10) Pub. No.: US 2004/0094185 A1
(43) Pub. Date: May 20, 2004

(54) Method for conveying dishes in a tunnel dishwasher, and a tunnel dishwasher

(76) Inventor: Roger Fransson, Vaxjo (SE)

Correspondence Address: HARNESS, DICKEY & PIERCE, P.L.C., P.O. BOX 8910, RESTON, VA, 20195, US

(21) Appl. No.: 10/665,113

(22) Filed: Sep. 22, 2003

(30) Foreign Application Priority Data
Nov. 15, 2002 (FI) 20022038

(51) Int. Cl. B08B 9/20

(52) U.S. Cl. 134/25.2; 134/25.1; 134/25.4; 134/25.5; 134/32; 134/58 D

(57) ABSTRACT

The invention relates to a method for conveying dishes in a tunnel dishwasher and to a tunnel dishwasher. The tunnel dishwasher (1) comprises at least one washing zone (2, 3, 4) and a first conveyor (5a) arranged to move alternately forwards (F) and backwards (R), during which forward (F) motion the dishes (11) to be washed are arranged to be moved along with the first conveyor (5a) relative to the washing zone (2, 3, 4). The tunnel dishwasher (1) further comprises at least a second conveyor (5b) arranged to move in the opposite direction relative to the first conveyor (5a) in such a way that the first and the second conveyor (5a, 5b) are arranged to convey the dishes (11) to be washed alternately forwards (F).

### BACKGROUND OF THE INVENTION

The invention relates to a method for conveying dishes in a tunnel dishwasher.

Further, the invention relates to a tunnel dishwasher comprising at least one washing zone and a first conveyor arranged to move alternately forwards and backwards, during which forward motion the dishes to be washed are arranged to be moved along with the first conveyor relative to the washing zone.

The dishes to be washed in a tunnel dishwasher are arranged on bases, typically racks, which are transferred with a conveyor, i.e. a carrier, of a conveyor apparatus through the different units. The conveyor moves reciprocatingly in the longitudinal direction of the apparatus, rotated by a crankshaft. With this respect, a tunnel dishwasher differs essentially from another dishwasher type widely in use, i.e. a conveyor chain machine, in which a conveyor chain moves only forwards. A tunnel dishwasher typically comprises successive prewash, wash and rinsing zones.

A tunnel dishwasher comprises hooks arranged at given intervals in the longitudinal direction of the washer, which hooks can be arranged in a conveyor. Thus, the hooks push a rack forwards at the same time as the conveyor moves forwards. When the conveyor starts to move backwards, the hooks come down, whereby the racks remain immovable on guide tracks. When the conveyor restarts the forward motion, the hooks move up, gripping the rack and conveying it forwards until the next backward motion begins. A tunnel dishwasher can be implemented also in such a way that the hooks are arranged on guide tracks, and the conveyor moves racks forwards by means of the friction between the conveyor and the rack. The hooks arranged on the guide tracks prevent the racks from moving backwards when the conveyor moves backwards.

A conveyor apparatus moving reciprocatingly is less expensive to manufacture than a chain conveyor, and it is also easier to keep clean.

A drawback of a conveyor moving reciprocatingly is its uneconomical manner of operation. The rack and the dishes move forwards in a tunnel dishwasher only when the conveyor is moving forwards. Thus, if the desired capacity for the washer is 200 washed racks per hour, for example, the average speed of the conveyor must be 400 racks per hour. In other words, when in motion, the rack moves at double speed relative to the capacity speed. This causes the problem that a dish arranged in the rack passes through the washing and rinsing jets of the washer at this double speed, whereby the rinsing flow directed at the dish is only half of what it would be in a conveyor chain dishwasher of the same capacity. This is because the reciprocating motion of the conveyor is longer than the dimension of an individual dish in the direction of travel of the conveyor, whereby the dish moves totally through the rinsing water jet at the travelling speed used. The uneconomical manner of operation is particularly obvious in the rinsing zone, where the depth of the rinsing jet in the proceeding direction is only about 30 mm. In order for the rinsing efficiency of the tunnel washer to be equal to the efficiency of a conveyor chain dishwasher of the same capacity, the rinsing flow, i.e. water consumption, must be twofold compared with that. Typically, the highest operating costs of a tunnel washer are caused by rinsing water and particularly heating of the rinsing water.

### BRIEF DESCRIPTION OF THE INVENTION

An object of the invention is to provide a method for controlling a conveyor apparatus of a tunnel dishwasher, and a tunnel dishwasher, for solving the above problem.

A method for controlling a conveyor apparatus of a tunnel dishwasher according to the invention is characterized by using at least two conveyors, the first of the conveyors moving forwards at the same time as the second of the conveyors moves backwards, and vice versa; and by moving the conveyors alternately forwards, whereby the dishes to be washed move along with the forward-moving conveyor relative to the washing zones.

A tunnel dishwasher according to the invention is characterized in that the tunnel dishwasher comprises, in addition to a first conveyor, at least a second conveyor arranged to move in the opposite direction relative to the first conveyor in such a way that the first and the second conveyor are arranged to convey the dishes to be washed alternately forwards.

An advantage of the invention is that the dishes do not remain immovable in the dishwasher but are conveyed virtually uninterruptedly forwards through the washing zones. Thus, the target capacity set for the washer is achieved at a conveyor average speed that is essentially lower than previously, whereby the use of the rinsing water is made more efficient. In this way, the rinsing result can be improved without decreasing the washer capacity or increasing water consumption, because the dish to be washed stays under the water jets significantly longer, and the rinsing flow directed at the dish is significantly larger than in a prior art washer of the same capacity. A second advantage of the invention is that the rinsing water consumption can be decreased, because the amount of water flowing through a rinsing nozzle per time unit can be decreased without deteriorating the rinsing result. A third advantage of the invention is that the washer capacity can be increased essentially without compromising on the rinsing result. According to a preferred embodiment of the invention, the opposite motion of the conveyors is achieved with one single power unit.

### BRIEF DESCRIPTION OF THE FIGURES

The invention will now be described in greater detail with reference to the attached drawings, of which

FIG. 1a shows a schematic side view and partial section of an embodiment of the tunnel dishwasher according to the invention;

FIG. 1b shows a top view of conveyors of the tunnel dishwasher shown in FIG. 1a;

FIG. 2 shows a schematic top view of conveyors of a tunnel dishwasher according to a second embodiment of the invention;

FIG. 3 shows a schematic top view of conveyors of a tunnel dishwasher according to a third embodiment of the invention; and

FIG. 4 shows a schematic front view of conveyors of a tunnel dishwasher according to a fourth embodiment of the invention.

### DETAILED DESCRIPTION OF THE INVENTION

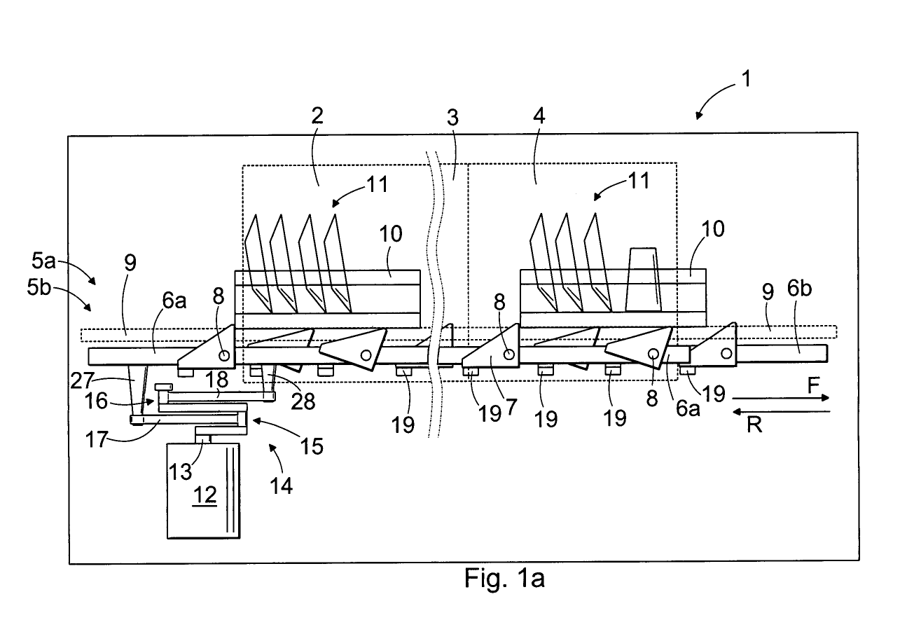

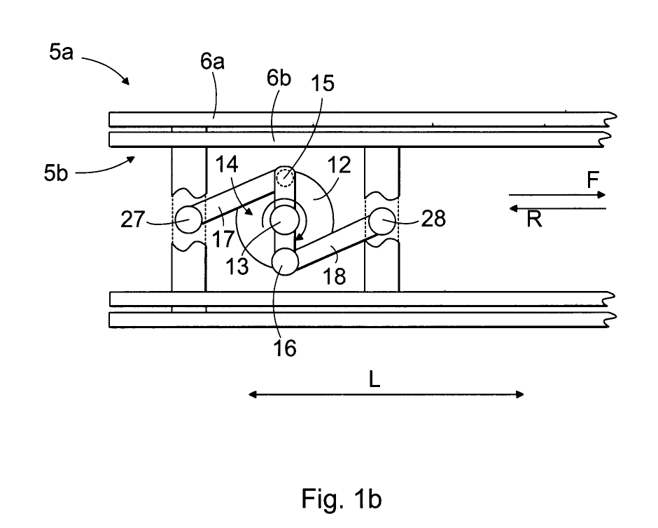

FIG. 1a shows schematically a side view and partial section of an embodiment of the tunnel dishwasher according to the invention, and FIG. 1b shows a top view of conveyors of the tunnel dishwasher according to FIG. 1a.

A tunnel dishwasher 1—hereafter a dishwasher 1—comprises a prewash zone 2, a wash zone 3 and a rinsing zone 4, which are arranged immediately one after another. Prewash is carried out in the prewash zone 2, main wash in the wash zone 3 and rinsing in the rinsing zone 4. The zones comprise wash and rinsing means, and the systems related to them are known as such, so they are not described in more detail in this context. It is to be noted that a dishwasher does not necessarily have all these zones and that it is not necessary to arrange the zones immediately one after another.

Further, the dishwasher 1 comprises a first conveyor 5a and a second conveyor 5b, both of which have an elongated frame 6a, 6b. The conveyors 5a, 5b are arranged in such a way relative to the washer frame that they can move forwards F and backwards R in the longitudinal direction L of the washer. The length of the reciprocating motion is usually 50 to 150 mm, but the length of the motion can also be other than that. It is to be noted that the washer frame is not shown in FIGS. 1a and 1b.

Hooks 7 are arranged in the frame 6a, 6b of both conveyors, the distance between the hooks corresponding to the length of the conveyor 5a, 5b motion or being shorter. The hooks 7 are attached to the frame 6a, 6b by means of a hook shaft 8. The hook 7 can turn supported by the shaft 8 relative to the frame 6a, 6b. It is to be noted that hooks 7 can be shaped in a way different from what is shown in the figure. In addition, at least part of the hooks 7 can be placed in groups of several hooks, in which the distance between successive hooks is shorter than the distance between hook groups.

Further, the washer 1 comprises guide tracks 9 indicated by a broken line in the figures, leading through the washing zones and being attached relative to the washer frame.

In the dishwasher, dishes 11 to be washed are arranged in racks 10. The racks 10 are supported by the guide tracks 9 in the dishwasher. The hooks 7 are weighted in such a way that gravity tends to turn a hook support 19 to a vertical position, the first, fourth and fifth hook 7 from the left being in this position in the figure. The upper part of the hooks 7 is in this position above the upper surface of the guide tracks 9. Motion between different positions of the hooks 7 can also be implemented in other ways known as such, for example with mechanical control.

The hooks 7 attached to the conveyor 5a, 5b move forwards along with the conveyor in question, i.e. in the direction shown by arrow F, and backwards, i.e. in the direction shown by arrow R. When, for example, the first conveyor 5a moves forwards F, one of its hooks 7 grips the rack 10 and pushes it along the guide tracks 9 by the length of the conveyor motion. When the forward motion of the first conveyor 5a ends, the conveyor begins to move backwards, in other words in the direction shown by arrow R.

While the first conveyor 5a moves forwards F, the second conveyor 5b moves backwards R. When, during the backwards motion R, the slanting rear surface of the hooks 7 attached to the second conveyor 5b encounters the rack 10, the hook 7 is turned, pressed by the rack 10, into a clockwise position, the second, third, sixth and seventh hook 7 from the left being in this position in the figure. In this position, the hook 7 moves under the rack 10 backwards relative to the rack. Having passed the rack 10, the hook 7 returns into a vertical position. When the direction of travel of the first conveyor 5a changes in the backwards R direction, also the direction of travel of the second conveyor 5b changes to the opposite, in other words to forward F motion. Thus, one or some of the hooks 7 of the second conveyor 5b pushes/push the rack 10 with it, whereas the hooks of the first conveyor 5a are pressed down when they encounter the rack 10. In this way, both conveyors 5a, 5b move alternately forwards F, carrying the racks 10 with them.

The motion of the conveyors 5a, 5b is provided by a power unit 12, which is in the embodiment of FIG. 1 an electric motor mounted relative to the frame of the dishwasher 1. A crankshaft 14 is connected to the shaft 13 of the electric motor, which crankshaft rotates on horizontal plane, rotated by the shaft 13. Between the power unit 12 and the crankshaft 14, a gearing can be arranged which transforms the rotation speed of the power unit into suitable rotation speed for the crankshaft 14. For the sake of simplicity, control devices related to the use of the power unit 12 or other corresponding components are not shown in the figures.

The crankshaft 14 comprises two crank pins 15 and 16 arranged, relative to the shaft 13, on opposite sides of the shaft; in other words, the crank pins have a phase difference of 180° relative to each other. The crank pins 15, 16 are parallel relative to the power unit shaft 13. When the crankshaft 14 rotates, both crank pins 15, 16 go round in circles of the same size about the shaft 13.

A first connecting rod 17 is attached to the first crank pin 15 of the crankshaft 14, and correspondingly, a second connecting rod 18 is attached to the second crank pin 16. One end of the first connecting rod 17 is attached to a first shifter 27 attached to the frame 6a of the first conveyor, and correspondingly, one end of the second connecting rod 18 is attached to a second shifter 28 attached to the frame 6b of the second conveyor. The connecting rod 17, 18 is attached turnably to the corresponding crank pin 15, 16 and shifter 27, 28.

When studying FIG. 1b, in particular, it can be seen that when the power unit 12 rotates the crankshaft 14, the crank pins 15, 16 move in opposite directions in the longitudinal direction L of the washer. For instance, when the first crank pin 15 moves forwards F, the second crank pin 16 moves backwards R, and vice versa. Since the conveyors 5a, 5b are attached to the washer frame movably in the longitudinal direction L, and since they are connected to the crank pins 15, 16 by means of connecting rods 17, 18, the power unit 12 moves the conveyors 5a, 5b reciprocatingly forwards F and backwards R, but always in the opposite directions. The speeds of the forwards F and backwards R motions are always equal but have opposite directions. It is to be noted in this context that the figures do not, for the sake of clarity, show bearings, sliding surfaces, controllers or other like components needed for attaching the conveyors movably relative to the frame of the washer 1.

The dishes 11 move forwards F substantially all the time and do not stay immovable half of the time as in prior art tunnel dishwashers. Thus, if the desired washer capacity is 200 racks per hour, for example, this aim is achieved with the conveyor average speed forwards F being 200 racks per hour. In prior art washers, by contrast, the conveyor average speed forwards F must be 400 racks per hour to achieve the same capacity. Since in this exemplary case the speed of the motion taking the rack forwards is half of the speed of a corresponding prior art washer, the dishes 11 in the rack 10 stay double time under the rinsing jets. In this way, the rinsing flow directed at the dishes 11 is twofold compared with the rinsing flow in a prior art washer of the same capacity. In other words, the dishes will be rinsed much more efficiently. A second embodiment of the invention decreases the rinsing water consumption, because the amount of water flowing through a rinsing nozzle per time unit can be decreased by about 50% without deteriorating the rinsing result. A third alternative is to raise the whole washer capacity without compromising on the rinsing result. It is to be noted that the speeds presented here are only exemplary.

Besides an electric motor, the power unit 12 may be a pneumatic actuator, a hydraulic actuator or the like. The tunnel dishwasher 1 may also comprise three, four or more conveyors. The conveyors are arranged to move at different phases relative to each other in such a way that the forwards F motion of the dishes 11 is as even as possible. For example, if the tunnel dishwasher 1 comprises three conveyors, and their power transmission is provided by means of one crankshaft 14, the crankshaft thus comprises three crank pins arranged at a phase difference of 120° relative to each other. The greater the number of conveyors moving at different phases, the more even is the forward F proceeding speed of the dishes 11.

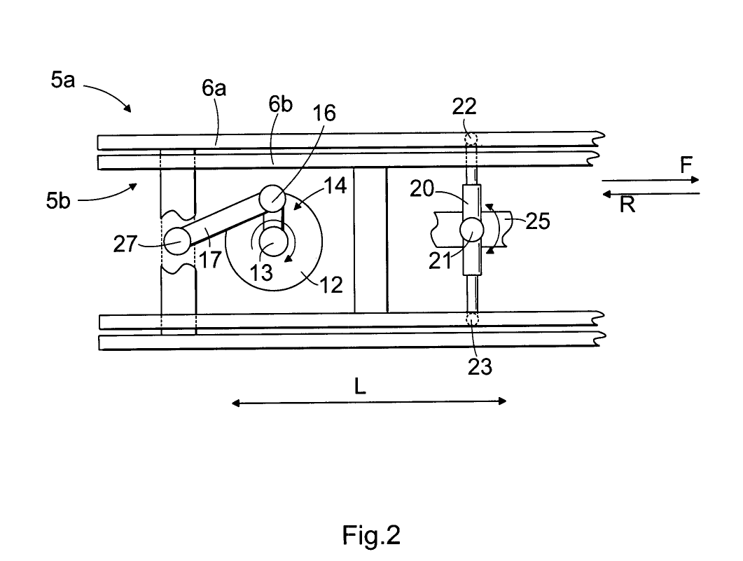

FIG. 2 shows schematically a top view of a second embodiment of the tunnel dishwasher according to the invention. The tunnel dishwasher 1 is similar to the embodiment shown in FIGS. 1a, 1b, except for the power transmission between the power unit 12 and conveyors 5a, 5b.

In this case, the crank pin of the crankshaft 14 rotated by the power unit 12 is connected to the first conveyor 5a by means of the connecting rod 17. The crankshaft—connecting rod structure transforms the rotating motion of the power unit 12 into reciprocating motion of the first conveyor 5a. Alternatively, the power unit 12 is a power unit providing linear motion, such an electric spindle motor or a linear motor, a hydraulic cylinder, pneumatic cylinder or the like.

A lever 20 is arranged between the first and the second conveyor 5a, 5b, which lever is attached rotationally by its middle point to a frame 25 by means of a joint 21. A first end 22 of the lever is attached turnably to the frame 6a of the first conveyor, and correspondingly, a second end 23 is attached turnably to the frame 6b of the second conveyor.

While the crankshaft rotated by the power unit 12 moves the first conveyor 5a in one direction in the longitudinal direction L of the washer, the lever 20 rotating about its middle point forces the second conveyor 5b to move at a corresponding speed in the opposite direction. The length of the lever 20 is changing on both sides of the lever middle point, because the distance between the attachment points of the lever ends 22, 23 changes as the respective location of the conveyors 5a, 5b changes. The changing length of the lever can be implemented by means of a telescope structure, for example. A second option is to arrange grooves or tracks curving to the side on the conveyor frames 6a, 6b on which the lever ends are movably arranged and along which the lever ends move as the location of the conveyors changes.

In this way, a very simple structure can provide motion of the conveyors 5a, 5b in different directions with one power unit 12.

Power transmission from the first conveyor 5a to the second conveyor 5b can be implemented in such a way that a gearwheel mounted on a bearing is arranged in the washer frame 25 between the conveyor frames 6a, 6b, and gear racks are arranged in the gearwheel on the corresponding surfaces of the conveyor frames 6a, 6b. The gearwheel transmits the motion of the first conveyor 5a, having turned into the opposite, to the second conveyor 5b. Instead of a gearwheel, a friction wheel and friction surfaces pressed against it can be used.

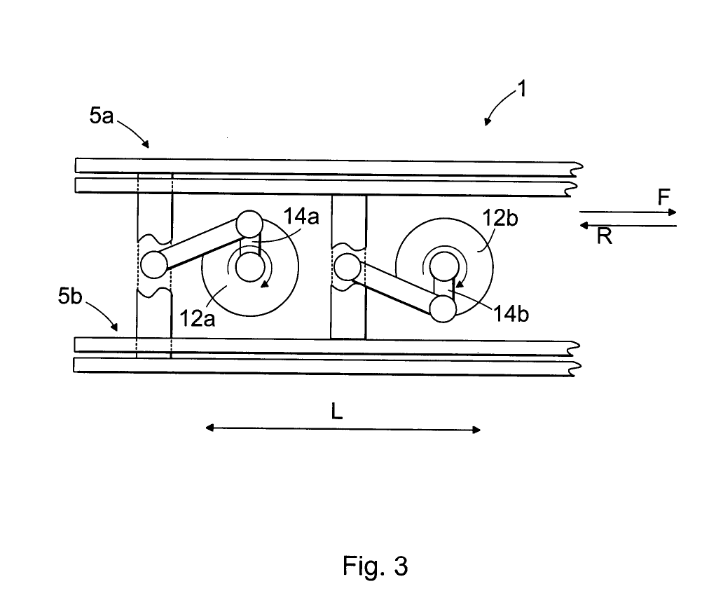

FIG. 3 shows schematically a top view of a third embodiment of the tunnel dishwasher according to the invention. The washer 1 comprises two separate power units 12a, 12b, the first 12a of which is arranged to move the first conveyor 5a and the second 12b of which is correspondingly arranged to move the second conveyor 5b. The rotational movement of the power units 12a, 12b is transformed into reciprocating motion of the conveyors 5a, 5b by means of a crankshaft 14a, 14b. The crankshafts of the power units 12a, 12b are at a phase difference of 180° relative to each other, and in addition, their rotational speeds are essentially the same. Thus, the conveyors 5a, 5b always have opposite directions of travel.

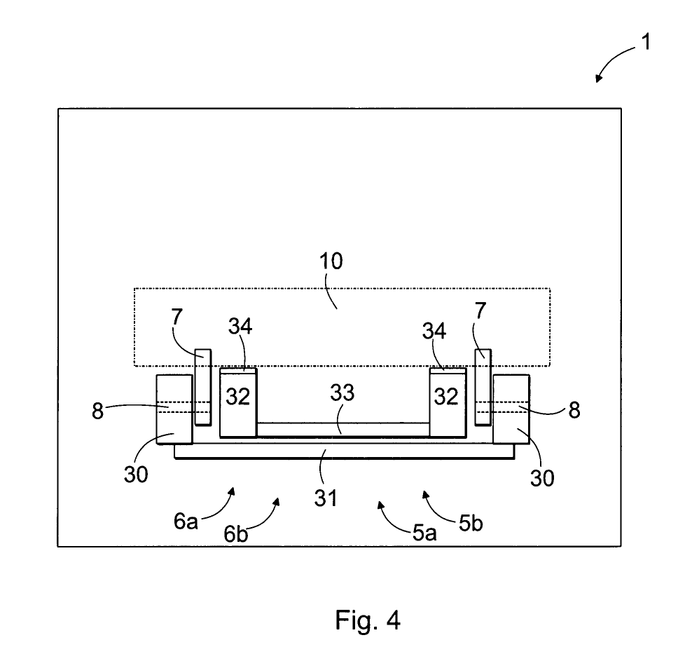

FIG. 4 shows schematically a front view of conveyors of the tunnel dishwasher according to a fourth embodiment of the invention. The frame 6a of the first conveyor comprises two longitudinal first beams 30 that are connected to each other with transverse first beams 31. Correspondingly, the frame 6b of the second conveyor comprises two longitudinal second beams 32 that are connected to each other with transverse second beams 33. The conveyors 5a, 5b move forwards and backwards in accordance with the principles described in the preceding figures.

Hooks 7 turning about the shaft 8 are arranged in the first longitudinal beams 30 in the way shown in FIG. 1, for example. When the first conveyor 5a moves forwards, the hooks 7 are in the upper position, carrying dishes or the rack 10 with them. It is to be noted that the rack 10 is indicated by a dotted broken line.

Friction surfaces 34 are arranged on the upper surface of the second longitudinal beams 32. The friction surfaces 34 can be a separate component manufactured of elastomer or plastic, for instance, and attached to the beam, or it can be the surface of the beam 32 treated in a suitable manner, such as by roughening or grooving. The friction surface 34 can also be an ordinary beam surface, the friction properties of which have not been modified in any particular way. When the conveyor 5b moves the rack forwards, the friction between the friction surfaces 34 and the rack 10 is so great that the rack 10 presses the hooks 7 to the lower position and moves then sufficiently forwards along with the second conveyor 5b. When the first conveyor 5a moves forwards, its hooks 7 force the rack 10 to move forwards despite the friction resisting the motion, caused by the friction surfaces 34.

The upper surfaces of the second longitudinal beams 32 of the second conveyor 5b are arranged somewhat higher than the corresponding beams 30 of the first conveyor 5a. In this way, it is ensured that the whole weight of the rack 10 is directed at the friction surfaces 34. At the same time, the second conveyor 5b functions as guide tracks which support the racks 10 when they move in the dishwasher 1. Also in the embodiments of FIGS. 1a to 3, one of the conveyors can be employed as guide tracks, in which case it is not necessary to use separate guide tracks 9.

The drawings and the related description are only intended to illustrate the idea of the invention. The details of the invention can vary within the claims. For example, it is not necessary to arrange the hooks 7 in the longitudinal beams 30, 32, but they can also be arranged in the transverse beams 31.

1. A method for conveying dishes in a tunnel dishwasher, characterized by using at least two conveyors (5a, 5b), the first of the conveyors (5a) moving forwards (F) at the same time as the second of the conveyors (5b) moves backwards (R), and vice versa; and by moving the conveyors (5a, 5b) alternately forwards (F), whereby the dishes (11) to be washed move along with the forward-moving (F) conveyor (5a, 5b) relative to the washing zones (2, 3, 4).

2. A method according to claim 1, characterized by that the dishes (11) to be washed being arranged in washing racks (10), in which they travel through the tunnel dishwasher (1), carried by the conveyors (5a, 5b).

3. A tunnel dishwasher comprising at least one washing zone (2, 3, 4) and a first conveyor (5a) arranged to move alternately forwards (F) and backwards (R), during which forward (F) motion the dishes (11) to be washed are arranged to be moved along with the first conveyor (5a) relative to the washing zone (2, 3, 4), characterized in that the tunnel dishwasher (1) comprises, in addition to a first conveyor (5a), at least a second conveyor (5b) arranged to move in the opposite direction relative to the first conveyor (5a) in such a way that the first and the second conveyor (5a, 5b) are arranged to convey the dishes (11) to be washed alternately forwards (F).

4. A tunnel dishwasher according to claim 3, characterized in that it comprises one power unit (12, 12a, 12b) arranged to move both the first and the second conveyor (5a, 5b) forwards and backwards (F, R).

5. A tunnel dishwasher according to claim 3 or 4, characterized in that it comprises a lever (20) which is by its first end (22) turnably attached to the first conveyor (5a) and by its second end (23) turnably attached to the second conveyor (5b) and which is further attached by its middle point turnably to the dishwasher frame (25) in such a way that when the first conveyor (5a) is moving in one direction, the second conveyor (5b) is forced to move in the opposite direction, and that a power unit (12, 12a, 12b) moving the conveyor (5a, 5b) reciprocatingly forwards and backwards (F, R) is connected to one of the conveyors (5a, 5b).

6. A tunnel dishwasher according to claim 3, characterized in that it comprises two power units (12, 12a, 12b), both of which are arranged to move one conveyor (5a, 5b).

7. A tunnel dishwasher according to claim 3, characterized in that it comprises at least three conveyors (5a, 5b) arranged to move forwards and backwards at different phases relative to each other.

8. A tunnel dishwasher according to any one of claims 4 to 6, characterized in that the power unit (12, 12a, 12b) is an electric motor.

9. A tunnel dishwasher according to any one of claims 4 to 6, characterized in that the power unit (12, 12a, 12b) is a pneumatic actuator.

10. A tunnel dishwasher according to any one of claims 4 to 6, characterized in that the power unit (12, 12a, 12b) is a hydraulic actuator.

11. A tunnel dishwasher according to any one of claims 3 to 10, characterized in that the first conveyor (5a) is provided with turnable hooks (7) which move the dishes (11) to be washed forwards, and the second conveyor (5b) is provided with a surface the friction of which moves the dishes (11) to be washed forwards.
